(19) United States
(12) Patent Application Publication
(10) Pub. No.: US 2020/0173096 A1
(43) Pub. Date: Jun. 4, 2020

(54) FORCED AIR DRYING LOCKER

(71) Applicant: Williams Boot & Glove Dryers Inc., Surrey (CA)

(72) Inventor: Gary WILLIAMS, SURREY (CA)

(73) Assignee: Williams Boot & Glove Dryers Inc., Surrey (CA)

(21) Appl. No.: 16/203,675

(22) Filed: Nov. 29, 2018

(51) Int. Cl. D06F 58/10

(52) U.S. Cl. CPC D06F 58/10; F26B 9/06

(57) ABSTRACT

A locker cabinet is positioned over and supported by a plenum which contains a blower for forcing air upwards through apertures in the floor of the locker for rapidly drying wetted apparel stored in the locker. Tubes disposed over the apertures serve to support apparel items such as boots, gloves, and helmets. Louvered vents provided in the locker door near the top enable moistened air to discharge outside the locker. A well is provided in the floor to facilitate storage of items such as skis.

### BACKGROUND

The present disclosure relates to drying apparel and particularly apparel worn during sporting activities generating external or perspiration moisture on the apparel. Upon the wearer completing the sporting activities and removing the personal apparel, it is commonplace to store the apparel and associated equipment in a locker cabinet. The storage of this wetted apparel and equipment in a locker normally will not result in the apparel or garments drying sufficiently within an acceptable period of time to enable reuse. Heretofore, in order to provide the desired drying of the apparel after such sporting activity use, a separate dryer has been required for the apparel, before storage in a locker, with the associated sporting equipment, of necessity, being stored separately. This arrangement has not been deemed desirable and can result in lost apparel and equipment. Accordingly, it has been desired to provide a way or means of securely storing sporting apparel for drying after use along with the associated equipment in a secure facility and to simultaneously provide rapid drying of the wetted apparel.

### SUMMARY

The present disclosure provides a forced air drying cabinet of the type commonly referred to as a locker for drying and storage of wetted sporting apparel after use and includes provision for also storing equipment associated with the sporting activity such as, for example, skis or snowboards. The locker of the present disclosure is particularly suitable for drying boots, gloves, helmets, and coats associated with the sporting activity.

The combination forced air drying cabinet and storage unit of the present disclosure has a cabinet disposed over and supported on a plenum chamber containing a blower which, upon energization, provides forced air through apertures in the floor of the cabinet; and, a discharge vent is provided in the uppermost portion of the closure or locker door. The air discharge ports in the floor of the locker cabinet are provided with supports for such items as boots, gloves, and helmets, and in the illustrated version, the supports comprise tubes disposed over a plurality of discharge orifices. The closure for the cabinet includes a latching and locking mechanism; and, the vent in the closure is provided with a plurality of louvers. In the illustrated version, the floor of the locker cabinet is provided with a well which extends downwardly into the plenum chamber below the floor, the well is configured to be suitable for having an end of items such as skis or skateboards disposed therein for maintaining such items in the desired position within the locker to facilitate and not interfere with rapid drying of the garments disposed therein and to maximize space for garments. The plenum has a blower disposed therein with a blower air inlet provided through the wall of the plenum such that, upon energization, the blower forces air, which may be warmed by a heater, upwardly through the support tubes and into the interior of the cabinet, flowing upwards to discharge through the vent in the upper region of the closure. The drying cabinet of the present disclosure thus provides for rapid drying of wetted apparel and garments disposed therein and for storage of associated sporting equipment in a manner which combines the drying function with secure storage.

### BRIEF DESCRIPTION OF THE DRAWINGS

FIG. 1 is a perspective view of the forced air drying locker of the present disclosure with the closure in the open position to show the air discharge tubes provided in the floor of the cabinet;

FIG. 2 is a perspective view of the cabinet of FIG. 1 as fabricated with the closure prior to assembly onto the plenum structure;

FIG. 3 is a perspective view of the floor of the cabinet in an exploded view with the sub-assembly of the well; and

FIG. 4 is a perspective view of the plenum and blower sub-assembly prior to attachment to the cabinet of FIG. 2.

### DETAILED DESCRIPTION

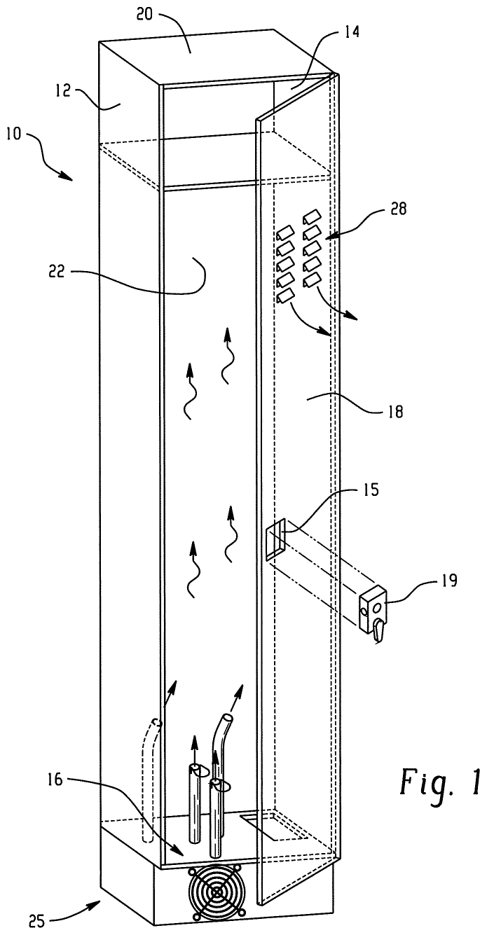

Referring to FIG. 1, the forced air drying locker of the present disclosure is indicated generally at 10 and includes a left-hand side wall 12, a right-hand side wall 14, a floor indicated generally at 16, a closure member or door 18, which in the present practice is hinged to the side wall panel 14, and a back wall panel 22. A top panel or ceiling 20 is attached to the sides 12, 14, and the back wall 22. The cabinet comprising side walls 12, 14, back wall 22, and top 20, including the floor 16, is received over and supported by a plenum assembly indicated generally at 25. In the present practice, the closure or door 18 includes an air vent adjacent the upper end thereof which, in the present practice, is provided in the form of a plurality of louvers indicated generally at 28. A latch and locking mechanism is provided in a cut-out 15 formed in door 18.

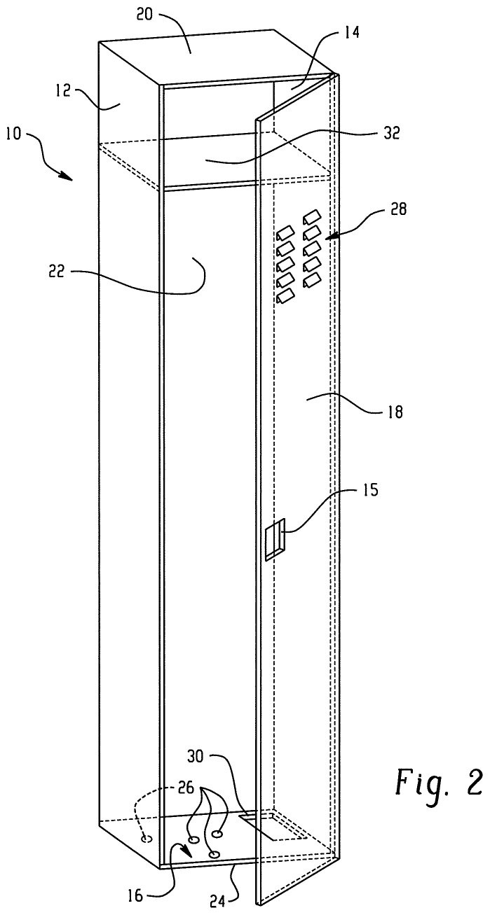

The floor 16 includes a panel 24 attached to the side panels 12, 14 and back panel 22 as shown in FIG. 2. The floor panel 24 has at least one air discharge port formed therein; and, in the version shown in FIG. 2, includes a plurality of spaced ports 26. The floor panel 24 also has a cut out indicated at 30 for receiving therein a well, as will hereinafter be described in detail. In the present practice, the cabinet has a shelf 32 disposed therein proximate the top panel 20 for convenient storage of personal items.

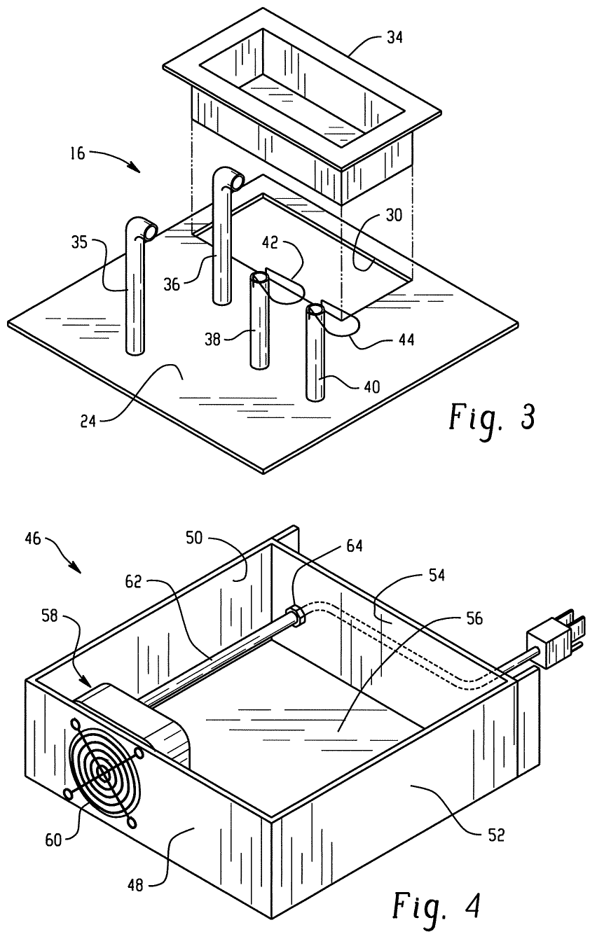

Referring to FIG. 3, the floor sub-assembly 16 has a flanged well 34, shown in exploded view received in the cut out 30 to extend downwardly through the floor panel 24. Each of the apertures 26 (shown in FIG. 2) has a support tube received thereover and connected thereto for directing flow upward into the interior of the cabinet. In the version shown in the drawings, a pair of the tubes 35, 36 have the upper end thereof formed at a generally right angle thereto to prevent the weight of garments received thereover from blocking flow. Another pair of the discharge tubes 38, 40 each have a wire loop 42, 44, respectively, provided in the upper end thereof for supporting items, such as boots, to prevent the weight of the footwear from blocking flow from the tubes.

Referring to FIG. 4, a sub-assembly of the plenum indicated generally at 46, has a front wall 48, oppositely disposed, left and right side walls 50, 52 respectively, attached to the front wall 48; and, a rear wall 54 is attached to the side walls 50, 52. In the version shown in FIG. 4, a floor panel 56 is provided under the side walls and attached thereto. However, if assembly 10 is to be situated on a sufficiently flat and level surface, if desired, the lower panel 56 may be omitted. A blower comprising a motorized fan, indicated generally at 58, is attached to the front wall 48 on the inside thereof. An air inlet 60 is provided through the front panel 48 which air inlet may include a protective wire grill as shown in FIG. 4. The blower 58 is configured to discharge air into the plenum 46 and which then is forced upwardly through the tubes 35, 36, 38, 40. The motorized fan 58 is connected to a power cable 62 which extends outwardly through the wall 54 of the plenum through a grommeted aperture 64. In the present practice, the floor sub-assembly 16 is attached to the cabinet walls 12, 14 and back wall 22 and the cabinet is then positioned over the plenum sub-assembly 46 and secured thereto in any convenient manner such as, for example, fasteners or weldment.

It will be understood that if desired, the blower 58 may include a heating element (not shown) to warm the air discharged upwardly through the tubes 35, 36, 38, 40. The door or closure 18 has an aperture 15 provided therein adjacent the margin thereof into which may be conveniently mounted suitable latching and locking mechanism 19.

In operation, the blower 58 creates a sufficient pressure within the interior of the plenum 46 so as to cause air to be discharged upwardly through the tubes into the interior of the cabinet. Moistened air flows outwardly through the louvered vents 28, thereby effecting rapid drying of wetted garments disposed in the interior of the locker cabinet. The well 34 provides a suitable locator for positioning associated sporting items such as skis along with the wetted garments during drying to conveniently combine the two functions.

The exemplary embodiment has been described and illustrated with reference to the drawings. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A forced-air drying cabinet for garments, comprising:
(a) structure defining an enclosure having a floor, side walls, and a ceiling/upper wall defining a drying chamber, wherein the floor includes at least one air discharge port;
(b) a moveable closure member operable, upon user movement, to open and close the drying chamber;
(c) structure disposed on the underside of the floor defining a plenum chamber communicating with the at least one discharge port;
(d) a blower disposed in the plenum chamber end, operable upon connection to a source of power, to effect a flow of air in the plenum through the discharge port into the drying chamber; and,
(e) at least one garment support disposed in the drying chamber and connected to the at least one discharge port, the garment support operable to direct airflow upwards in the drying chamber.

2. The drying cabinet of claim 1, wherein the moveable closure member includes one of (i) a latching device and (ii) a locking device.

3. The drying cabinet of claim 1, wherein the at least one garment support includes a tubular member.

4. The drying cabinet of claim 1, wherein the structure defining a plenum chamber comprises a separable cabinet attached to the underside of the floor.

5. The drying cabinet of claim 1, wherein the floor includes a well extending into the plenum chamber.

6. The drying cabinet of claim 1, wherein the moveable member includes a louvered vent port.

7. The drying cabinet of claim 1, wherein the at least one air discharge port includes a plurality of spaced ports each having a tubular garment support connected thereto.

8. The drying cabinet of claim 7, wherein at least one of the tubular garment supports has a loop provided thereon located proximate the upper end thereof.

9. The drying cabinet of claim 1, wherein the movable closure member has a vent located proximate the upper margin thereof.

10. The drying cabinet of claim 1, further comprising a shelf mounted proximate the ceiling/upper wall.

11. The drying cabinet of claim 1, wherein the structure defining the plenum includes an air inlet.

12. The drying cabinet of claim 1, wherein the moveable closure member includes an air vent port.
